(19) United States
(12) Patent Application Publication
(10) Pub. No.: US 2013/0151192 A1
(43) Pub. Date: Jun. 13, 2013

(54) Sensor for Detecting Temperature Gradients

(71) Applicant: Ran Gilad-Bachrach, Bellevue, WA (US)

(72) Inventor: Ran Gilad-Bachrach, Bellevue, WA (US)

(73) Assignee: MICROSOFT CORPORATION, Redmond, WA (US)

(21) Appl. No.: 13/315,530

(22) Filed: Dec. 9, 2011

(51) Int. Cl. G06F 15/00; G01K 11/30; G01K 7/16

(52) U.S. Cl. 702/133; 702/130; 702/135

(57) ABSTRACT

Different advantageous embodiments provide a monitoring system comprising one or more sensor systems and a processing unit. The one or more sensor systems is configured to monitor a subject for change in temperature and generate monitoring data. The processing unit is configured to analyze the monitoring data to generate a result.

### BACKGROUND

Temperature measurements are useful for monitoring and determining a number of different factors. In a health environment, measurement of human body temperature may be beneficial in monitoring or identifying a health issue. In other environments, such as manufacturing or storage environments, for example, measurement of ambient temperatures or product temperatures may be useful in maintaining optimal environmental conditions.

Thermal sensors respond to changes in temperature with a measurement output. Thermal sensors are used in health environments to measure human body temperature. However, thermal sensors are sensitive to environmental changes in temperature and often mechanical interferences as well. One prior method of handling this sensitivity is to use active thermal control methods, where an electric heater is coupled with the thermal sensor, the electric heater being kept at a constant temperature that matches the temperature of the object being monitored, in order to insulate the thermal sensor from external temperatures.

However, active thermal control consumes power rapidly, does not work well in high temperature environments, is cumbersome, and may be cost-prohibitive to manufacture. Therefore, it is desirable to have technology that addresses one or more of the issues discussed above in order to provide a power-efficient solution in a small form factor for continuously monitoring temperature over time.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards an apparatus comprising a plurality of thermal sensors, a data collector, and one or more thermal isolating layers. The plurality of thermal sensors comprises at least a first sensor and a second sensor. The one or more thermal isolating layers insulates the first sensor from the second sensor. The one or more thermal isolating layers is configured to create a different reaction between the first sensor and the second sensor because of the thermal resistance of the one or more isolating layers. The data collector is configured to capture temperature data from the plurality of thermal sensors.

Another aspect is directed towards a method for monitoring temperature change. A subject is monitored for change in temperature using a sensor system. The sensor system includes at least two sensors, each sensor separated from another sensor by at least one thermal isolating layer. Monitoring data is generated from temperature data captured over a period of time. The monitoring data includes a number of temperature measurements associated with the at least two sensors.

Yet another aspect is directed towards a monitoring system comprising one or more sensor systems and a processing unit. The one or more sensor systems is configured to monitor a subject for change in temperature and generate temperature data. The processing unit is configured to process the temperature data to generate a result.

Other advantages may become apparent from the following detailed description when taken in conjunction with the drawings.

### BRIEF DESCRIPTION OF THE DRAWINGS

The present invention is illustrated by way of example and not limited in the accompanying figures, in which like reference numerals indicate similar elements. The advantageous embodiments, as well as a preferred mode of use, further objectives and advantages thereof, will best be understood by reference to the following detailed description of an advantageous embodiment of the present disclosure when read in conjunction with the accompanying drawings, wherein:

FIG. 1 is an illustrative example of a health environment in which an advantageous example embodiment may be implemented;

FIG. 2 is a block diagram illustrating an example of a monitoring environment in accordance with an advantageous example embodiment;

FIG. 3 is a block diagram illustrating an example of a gradient detector in accordance with an advantageous example embodiment;

FIG. 4 is a graph illustrating an example of monitoring temperature change over time in accordance with an advantageous example embodiment;

FIG. 5 is a flow diagram representative of example steps in monitoring temperature change over time in accordance with an advantageous example embodiment; and

FIG. 6 is a block diagram representing an example computing environment into which aspects of the subject matter described herein may be incorporated.

### DETAILED DESCRIPTION

Various aspects of the technology described herein are generally directed towards an apparatus and method for continuously monitoring temperature. As will be understood, a sensor system uses a number of sensors separated by thermal isolating material to monitor and detect changes in temperature over time.

While the various aspects described herein are exemplified with a health environment directed towards monitoring human body temperature, it will be readily appreciated that other environments and subjects may benefit from the technology described herein. For example, the various aspects described herein may be used to monitor temperature changes in a manufacturing or storage environment.

Thus, as will be understood, the technology described herein is not limited to any type of environment or subject for temperature detection and monitoring. As such, the present invention is not limited to any particular embodiments, aspects, concepts, protocols, structures, functionalities or examples described herein. Rather, any of the embodiments, aspects, concepts, protocols, structures, functionalities or examples described herein are non-limiting, and the present invention may be used in various ways that provide benefits and advantages in temperature monitoring in general.

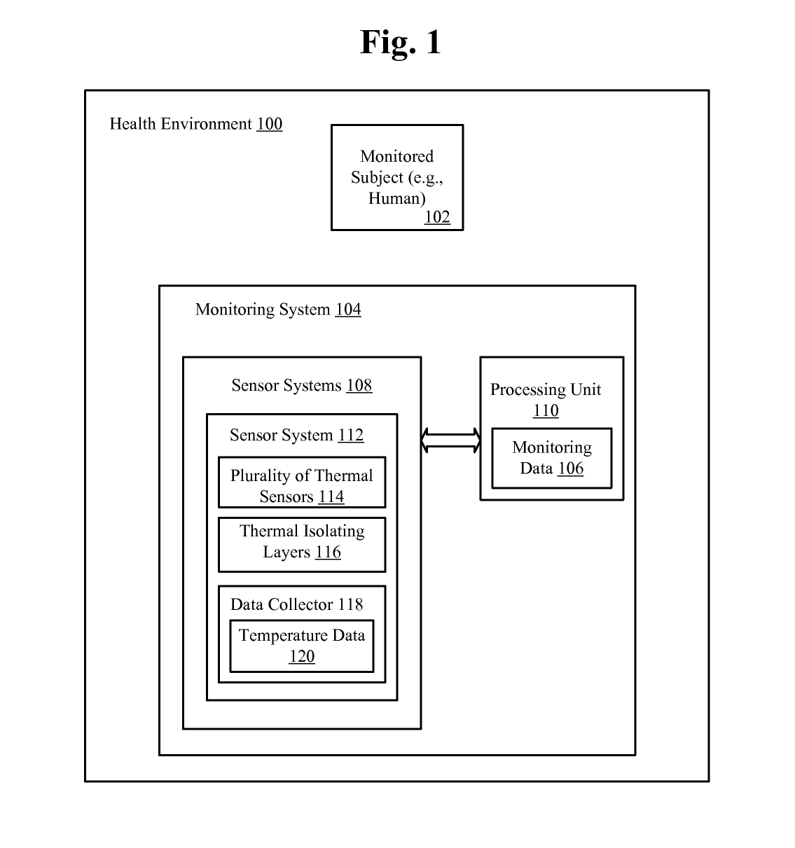

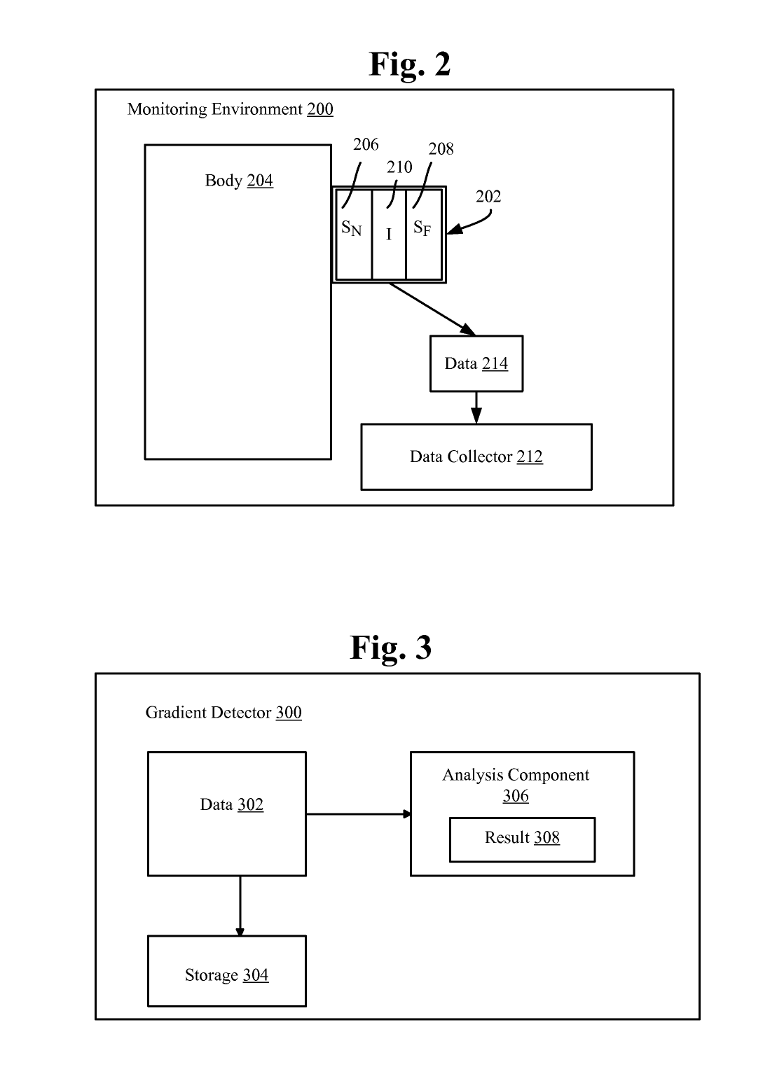

With reference now to the figures and in particular with reference to FIGS. 1-2, diagrams of data processing environments are provided in which advantageous embodiments of the present invention may be implemented. It should be appreciated that FIGS. 1-2 are only illustrative and are not intended to assert or imply any limitation with regard to environments in which different embodiments may be implemented. Many modifications to the depicted environments may be made.

With reference to the figures, FIG. 1 is an illustration of a health environment in which advantageous embodiments of the present invention may be implemented. A health environment 100 may be, for example, without limitation, a hospital, health care facility, clinic, home, office, school, and/or any environment in which a parameter of a living organism is monitored. Health environment 100 contains a subject 102, which in this example is a human or other living animal. The subject 102 may be the subject of a monitoring system 104 in this illustrative example.

The monitoring system 104 generates monitoring data 106. The monitoring system 104 includes one or more sensor systems 108 and a processing unit 110. The sensor systems 108 detect and measure temperature continuously over a period of time. The processing unit 110 may be any type of data processing system, including, without limitation, a computer, smart phone, laptop, handheld device, and/or any other suitable processing device. The sensor system 112 is an illustrative example of one implementation of the one or more sensor systems 108.

The sensor system 112 includes a number of thermal sensors 114, one or more thermal isolating layers 116, and a data collector 118. The number of thermal sensors 114 may be any type of sensor configured to detect and measure temperature. The number of thermal sensors 114 may include, for example, without limitation, thermocouple-based sensors, thermistor-based sensors, infrared-based sensors, and/or may be based upon any other suitable sensor technology for detecting and measuring temperature.

The one or more thermal isolating layers 116 may be any type of material suitable for insulating the number of thermal sensors 114 from each other and providing thermal resistance, that is, limited thermal conductivity. For example, in an illustrative implementation, the number of thermal sensors 114 may be a first sensor insulated from a second sensor by one or more thermal isolating layers, such as the thermal isolating layers 116. The thermal isolating layers 116 may include, for example, without limitation, a printed circuit board, fiberglass, silicon, foam, glass wool, and/or any other suitable material for insulating number of thermal sensors 114 and providing thermal resistance. The thermal isolating layers 116 are configured to create a different reaction between the number of thermal sensors 114 because of the thermal resistance of the thermal isolating layers 116 that separate each of the number of thermal sensors 114. Different reactions may include, for example, without limitation, a different point in time at which detection of a temperature change beings, a different angle of slope for a temperature gradient detected, and/or any other suitable difference in reaction between each of the number of thermal sensors 114.

A data collector 118 captures temperature data 120 generated by the number of thermal sensors 114. The data collector 118 may be, for example, without limitation, a microcontroller (MCU). Temperature data 120 may be temperature readings generated by the number of thermal sensors 114 over a period of time. For example, in one advantageous embodiment, the temperature data 120 may comprise a number of temperature measurements, where each temperature measurement is associated with a point in time. The data collector 118 may store, transmit, and/or release the temperature data 120.

In one advantageous embodiment, the data collector 118 may transmit the temperature data 120 to the processing unit 110 for processing and/or storage. In another advantageous embodiment, the data collector 118 may process the temperature data 120 and generate monitoring data 106 for transmission to a user interface, for example.

The processing unit 110 may receive the temperature data 120 and process the temperature data 120 to generate monitoring data 106, for example. The monitoring data 106 may be, for example, without limitation, statistical information of temperature gradients over time, analysis of temperature gradients over time, diagnostic information based on temperature gradients over time, and/or any other suitable information using the temperature data 120. For example, in one advantageous embodiment, the processing unit 110 may analyze the temperature data 120 using pattern recognition algorithms to identify and diagnose a health condition, outputting the resulting diagnosis as the monitoring data 106. In another illustrative example, processing unit 110 may include machine learning algorithms and use statistical methods to infer the result from the temperature data 120 received. Machine learning algorithms may include, for example, without limitation, support vector machine (SVM), k-nearest neighbor (k-NN), boosting, and/or any other suitable algorithms.

FIG. 1 is intended as an example, and not as an architectural limitation for different embodiments. For example, in other advantageous embodiments, the health environment 100 may have the monitoring system 104 monitor an animal or other living organism as the subject 102. In yet another advantageous embodiment, the monitoring system 104 may monitor a number of humans in addition to the human subject 102, for example. In yet another advantageous embodiment, monitoring system 104 may be implemented in an environment other than health environment 100, such as a manufacturing environment, industrial environment, or storage environment, for example. In yet another advantageous embodiment, processing unit 110 may be implemented within sensor system 112 to generate monitoring data 106 and transmit monitoring data 106 to an external user interface, for example.

As used herein, the phrase “at least one of”, when used with a list of items, means that different combinations of one or more of the items may be used and only one of each item in the list may be needed. For example, “at least one of item A, item B, and item C” may include, for example, without limitation, item A or item A and item B. This example also may include item A, item B, and item C or item B and item C.

As used herein, when a first component is connected to a second component, the first component may be connected to the second component without any additional components. The first component also may be connected to the second component by one or more other components. For example, one electronic device may be connected to another electronic device without any additional electronic devices between the first electronic device and the second electronic device. In some cases, another electronic device may be present between the two electronic devices connected to each other.

The different advantageous embodiments recognize and take into account that current sensors used in health environments to measure human body temperature are often subject to mechanical interference and sensitive to environmental changes in temperature. The use of active thermal coupling to overcome these sensitivities results in high power consumption and still does not work well in high temperature environments. Furthermore, active thermal coupling is cumbersome, and may be cost-prohibitive to manufacture.

Thus, various aspects of the subject matter described herein are directed towards an apparatus comprising a plurality of thermal sensors, one or more thermal isolating layers, and a data collector. The plurality of thermal sensors comprises at least a first sensor and a second sensor. The one or more thermal isolating layers insulate the first sensor from the second sensor. The one or more thermal isolating layers is configured to create a different reaction between the first sensor and the second sensor because of the thermal resistance of the one or more isolating layers. The data collector is configured to capture temperature data from the plurality of thermal sensors.

Another aspect is directed towards a method for monitoring temperature change. A subject is monitored for change in temperature using a sensor system. The sensor system includes at least two sensors, each sensor separated from another sensor by at least one thermal isolating layer. Monitoring data is generated from temperature data captured over a period of time. The monitoring data includes a number of temperature measurements associated with the at least two sensors.

Yet another aspect is directed towards a monitoring system comprising one or more sensor systems and a processing unit. The number of sensor systems is configured to monitor a subject for change in temperature and generate temperature data. The processing unit is configured to analyze the temperature data to generate a result.

With reference now to FIG. 2, an illustration of a monitoring environment is depicted in accordance with an advantageous embodiment. A monitoring environment 200 includes a sensor system 202. The sensor system 202 may be implemented using a data processing system, for example.

The sensor system 202 may be used to monitor a body 204, in this illustrative embodiment. The body 204 may be a human body, such as when the subject 102 in FIG. 1 is a human, for example. The sensor system 204 may communicate using a wireless network, in an illustrative example.

The sensor system 202 detects temperature information about the body 204 and the monitoring environment 200. The sensor system 202 includes a near sensor S_{N}, also labeled 206, a far sensor S_{F}, also labeled 208, an isolation layer 210, and a data collector 212. The near sensor 206 is disposed at a location within the sensor system 202 closest to the body 204. In an illustrative example, the sensor system 202 may be disposed adjacent to the body 204 in such a way as to place the near sensor 206 closest to the body 204 relative to the far sensor 208. In this example, the near sensor 206 detects temperature changes in body 204 before the far sensor 208 detects the same temperature changes in the body 204 because the near sensor 206 is disposed closest to the body 204. In another illustrative example, the near sensor 206 may be directly touching the body 204.

The far sensor 208 detects temperature changes in the monitoring environment 200 before the near sensor 206 detects the same temperature changes in the monitoring environment 200 because the isolation layer 210 separates the far sensor 208 from the near sensor 206. The near sensor 206 and the far sensor 208 are an illustrative example of one implementation of the number of thermal sensors 114 in FIG. 1.

The isolation layer 210 is disposed between the near sensor 206 and the far sensor 208 in this illustrative example. The isolation layer 210 provides thermal resistance, which provides a different reaction, such as a time difference in temperature change detection, between the near sensor 206 and the far sensor 208. In other words, because the isolation layer 210 separates the near sensor 206 and the far sensor 208, the far sensor 208 detects changes in temperature of the body 204 at a point in time after the near sensor 206 detects changes in the temperature of body 204. Similarly, the near sensor 206 detects changes in the temperature of the monitoring environment 200 at a point in time after the far sensor 208 detects changes in temperature of the monitoring environment 200, because of the disposition of the isolation layer 210 between the near sensor 206 and the far sensor 208. The isolation layer 210 is an illustrative example of one implementation of the one or more thermal isolating layers 116 in FIG. 1.

The data collector 212 collects data 214. The data 214 comprises information about the temperature detected by the sensor 206 and the sensor 208. The data collector 212 is an illustrative example of one implementation of the data collector 118 in FIG. 1. The data 214 may include information such as, without limitation, temperatures, dates of temperature readings, times of temperatures readings, and/or any other suitable information about temperatures detected.

The illustration of the monitoring environment 200 in FIG. 2 is not meant to imply physical or architectural limitations to the manner in which different advantageous embodiments may be implemented. Other components in addition and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

With reference to FIG. 3, an illustration of a gradient detector 300 is depicted in accordance with an advantageous embodiment. The gradient detector 300 is an illustrative example of one implementation of processing unit 110 in FIG. 1.

The gradient detector 300 detects temperature gradients in a monitoring environment, such as the monitoring environment 200 in FIG. 2. In one advantageous embodiment, the gradient detector 300 may be used to detect temperature gradients in a human being monitored, such as a human subject 102 in the health environment 100.

The gradient detector 300 may include, without limitation, data 302, storage 304, and an analysis component 306. The data 302 is an illustrative example of one implementation of the data 214 in FIG. 2. The data 302 may be retrieved by the gradient detector 300, in one advantageous embodiment, via a wireless network connected to a sensor system, such as the sensor system 202 in FIG. 2, for example. In another advantageous embodiment, the data 302 may be received by the gradient detector 300 via a transmission from a sensor system, such as the sensor system 202 in FIG. 2, for example.

The gradient detector 300 may store the data 302 in storage 304 for later processing, and/or may process the data 302 using the analysis component 306. Storage 304 is an illustrative example of one implementation of the storage devices 216 in FIG. 2.

The analysis component 306 may use any algorithm or algorithms to analyze the data 302 and generate a result 308. The result 308 may be, for example, without limitation, a report, an output, a diagnosis, and/or any other suitable result. In general, the algorithm or algorithms used by the analysis component 306 to analyze the data 302 depends upon the desired output. Algorithms used may include, without limitation, those directed towards thresholds, pattern recognition, trend analysis, identification of set parameters, comparisons, and/or any other suitable algorithms.

In an illustrative example, the gradient detector 300 may be used to detect the onset of a disease in a patient within the health environment 100 of FIG. 1. In this example, the gradient detector 300 receives the data 302 and analyzes the data 302 using the analysis component 306 to produce the result 308. The result 308 may be a report that takes into account the temperature changes in a patient during a period of time to provide an indication of whether or not the disease for which the patient is being monitored has developed, in this example.

In another illustrative example, instead of monitoring for a specific disease, the gradient detector 300 may be used to collect the data 302 for use in matching against known profiles of medical conditions. For example, a particular temperature change pattern may indicate that the monitored subject is likely suffering from some condition C, and not conditions A, B, D, E, F or G. Multiple samples taken from subjects known to be suffering from each of the particular conditions A through G may be collected and saved as profiles to be matched.

In other illustrative example, following a bone marrow transplant a monitored subject may have a compromised immune system that is sensitive to infection. In this example, gradient detector 300 may be used to continuously monitor the temperature of the monitored subject to detect changes that may indicate the onset of an infection.

The illustration of the gradient detector 300 in FIG. 3 is not meant to imply physical or architectural limitations to the manner in which different advantageous embodiments may be implemented. Other components in addition and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments. For example, in one illustrative embodiment, the gradient detector 300 may be implemented in data collector 118 of FIG. 1, and configured to transmit result 308 to a user interface.

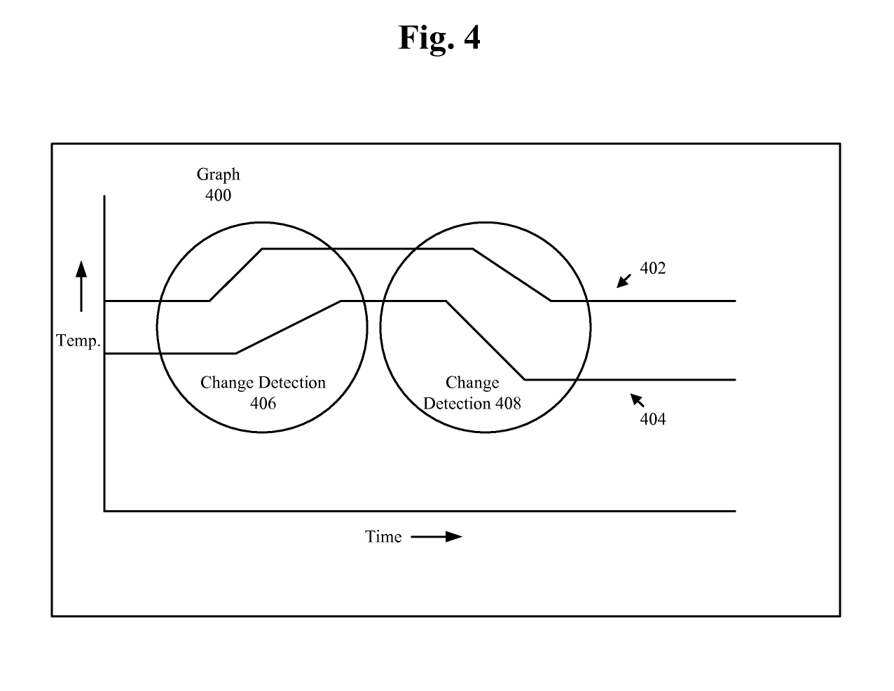

With reference now to FIG. 4, an illustration of monitoring temperature change over time is depicted in accordance with an advantageous embodiment. The graph in FIG. 4 represents data that may be captured by a sensor system, such as the sensor system 202 in FIG. 2 using the near sensor 206 and the far sensor 208, for example.

Graph 400 represents temperature change over time as detected by a number of sensors, such as number of thermal sensors 114 in FIG. 1, for example. In this example, line 402 represents temperature readings over time as detected by a sensor next to and/or in communication with skin of a body, such as the body 204 in FIG. 2, for example. Line 402 may represent readings from the near sensor 206 in FIG. 2, for example. Line 404 represents temperature readings over time as detected by a sensor that is more insulated relative to the sensor next to a body, such as the far sensor 208 in FIG. 2.

Change detection 406 represents one illustrative example, in which a first sensor next to and/or in communication with skin of a body may detect a change in temperature before a second sensor that is insulated from the first sensor by one or more thermal isolating layers, such as thermal isolating layers 116 in FIG. 1, for example. Line 402, representing measurements from a first sensor next to and/or in communication with skin, rises before and more rapidly than line 404, representing measurements from a second sensor separated from the first sensor and having greater thermal resistance than the first sensor. Change detection 406 may indicate a change in body temperature, in this illustrative example.

Change detection 408 represents one illustrative example, in which a first sensor next to and/or in communication with skin of a body may detect a change in temperature after a second sensor that is insulated from the first sensor by one or more thermal isolating layers. Line 402, representing measurements from a first sensor next to and/or in communication with skin, falls after and more slowly than line 404, representing measurements from a second sensor insulated from the first sensor and having less thermal resistance to ambient temperature than the first sensor, for example. Change detection 408 may indicate a change in ambient temperature, in this illustrative example.

The illustration of graph 400 in FIG. 4 is not meant to imply physical or architectural limitations to the manner in which different advantageous embodiments may be implemented. Other measurements and/or parameters in addition to and/or in place of the ones illustrated may be used. Some parameters may be unnecessary in some advantageous embodiments.

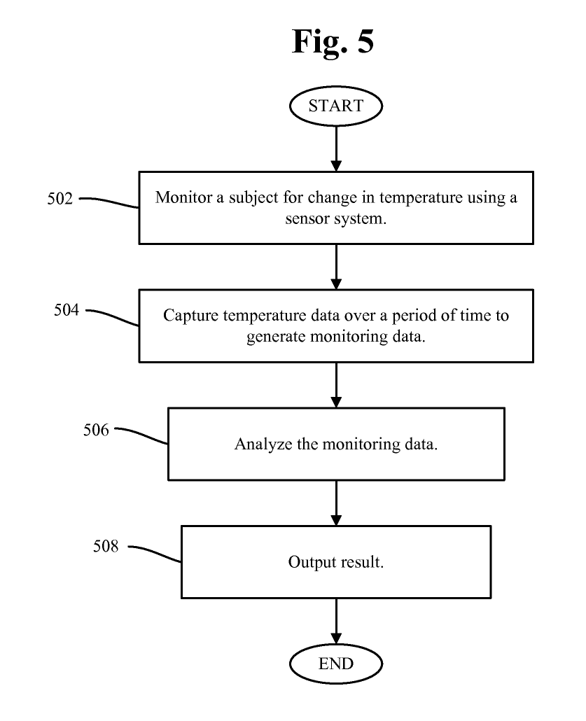

With reference now to FIG. 5, an illustration of a flow diagram of monitoring temperature change over time is depicted in accordance with an advantageous embodiment. The flow diagram in FIG. 5 represents an example process that may be implemented by a monitoring system, such as the monitoring system 104 in FIG. 1, for example.

The process begins by monitoring a subject for change in temperature using a sensor system (operation 502). The subject may be, for example, without limitation, a human, an animal, a product, and/or any other suitable subject for temperature monitoring. The sensor system may be, for example, the sensor system 112 in FIG. 1.

The process captures temperature data over a period of time to generate monitoring data (operation 504). The temperature data may be captured using a data collector, for example, such as the data collector 118 in FIG. 1. The period of time may be a specified period of time programmed into the sensor system monitoring the subject, in an illustrative example. In another example, the period of time may be continuous when the sensor system is in an operating state.

The process analyzes the monitoring data (operation 506) and outputs a result (operation 508), with the process terminating thereafter. The monitoring data may be analyzed by a processing unit, such as the gradient detector 300 in FIG. 3, for example. The result may be, for example, the result 308 in FIG. 3.

The flowcharts and block diagrams in the different depicted embodiments illustrate example architecture, functionality, and operation of some possible implementations of apparatus, methods and computer program products. In this regard, each block in the flow diagram or block diagrams may represent a module, segment, or portion of computer usable or readable program code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The different advantageous embodiments can take the form of an entirely hardware embodiment, an entirely software embodiment, or an embodiment containing both hardware and software elements. Some embodiments are implemented in software, which includes but is not limited to forms, such as, for example, firmware, resident software, and microcode.

Furthermore, the different embodiments can take the form of a computer program product accessible from a computer usable or computer readable medium providing program code for use by or in connection with a computer or any device or system that executes instructions. For the purposes of this disclosure, a computer usable or computer readable medium can generally be any tangible apparatus that can contain, store, communicate, propagate, or transport the program for use by or in connection with the instruction execution system, apparatus, or device.

The computer usable or computer readable medium can be, for example, without limitation an electronic, magnetic, optical, electromagnetic, infrared, or semiconductor system, or a propagation medium. Non limiting examples of a computer readable medium include a semiconductor or solid state memory, magnetic tape, a removable computer diskette, a random access memory (RAM), a read-only memory (ROM), a rigid magnetic disk, and an optical disk. Optical disks may include compact disk-read only memory (CD-ROM), compact disk-read/write (CD-RAN) and DVD.

Further, a computer usable or computer readable medium may contain or store a computer readable or usable program code such that when the computer readable or usable program code is executed on a computer, the execution of this computer readable or usable program code causes the computer to transmit another computer readable or usable program code over a communications link. This communications link may use a medium that is, for example without limitation, physical or wireless.

A data processing system suitable for storing and/or executing computer readable or computer usable program code will include one or more processors coupled directly or indirectly to memory elements through a communications fabric, such as a system bus. The memory elements may include local memory employed during actual execution of the program code, bulk storage, and cache memories which provide temporary storage of at least some computer readable or computer usable program code to reduce the number of times code may be retrieved from bulk storage during execution of the code.

Input/output or I/O devices can be coupled to the system either directly or through intervening I/O controllers. These devices may include, for example, without limitation to keyboards, touch screen displays, and pointing devices. Different communications adapters may also be coupled to the system to enable the data processing system to become coupled to other data processing systems or remote printers or storage devices through intervening private or public networks. Non-limiting examples are modems and network adapters are just a few of the currently available types of communications adapters.

The different advantageous embodiments recognize and take into account that current sensors used in health environments to measure human body temperature are often subject to mechanical interference and sensitive to environmental changes in temperature. The use of active thermal coupling to overcome these sensitivities results in high power consumption and still does not work well in high temperature environments. Furthermore, active thermal coupling is cumbersome, and may be cost-prohibitive to manufacture.

Thus, the different advantageous embodiments provide a system and methods for a power efficient monitoring system in a small form factor for continuously monitoring temperature over time.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

### Example Operating Environment

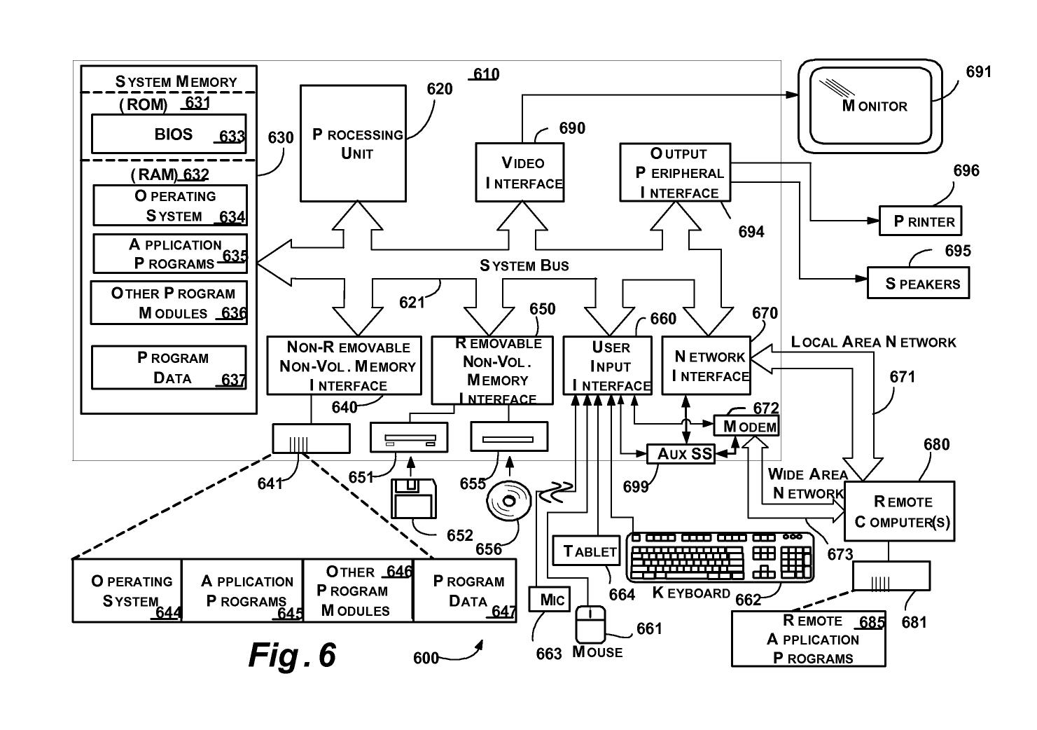

With reference now to FIG. 6, an illustrative example of a suitable computing and networking environment 600 is provided, into which the examples and implementations of any of FIGS. 1-6 as well as any alternatives may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the example operating environment 600.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an example system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component 674 such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are examples and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. An apparatus comprising:
a plurality of thermal sensors comprising at least a first sensor and a second sensor;
a data collector configured to capture temperature data from the plurality of thermal sensors; and
one or more thermal isolating layers, wherein the one or more thermal isolating layers insulates the first sensor from the second sensor, and wherein the one or more thermal isolating layers is configured to create a different reaction between the first sensor and the second sensor because of the thermal resistance of the one or more isolating layers.

2. The apparatus of claim 1, wherein the first sensor is exposed to the outside of the apparatus, and wherein the second sensor is separated from the first sensor by the one or more thermal isolating layers.

3. The apparatus of claim 1, wherein the data collector transmits the temperature data to a processing unit for analysis.

4. The apparatus of claim 1, wherein the data collector stores the temperature data.

5. The apparatus of claim 1, wherein the plurality of thermal sensors include at least one of a thermocouple-based sensor, a thermistor-based sensor, or an infrared sensor.

6. The apparatus of claim 1, wherein the one or more thermal isolating layers include at least one of a printed circuit board, silicon, foam, glass wool, or fiberglass.

7. The apparatus of claim 1, wherein the data collector comprises a microcontroller.

8. The apparatus of claim 1, wherein the temperature data includes a number of temperature measurements, and wherein each of the number of temperature measurement is associated with a point in time.

9. A method comprising:
monitoring a subject for change in temperature using a sensor system, wherein the sensor system includes at least two sensors separated by a thermal isolating layer; and
generating monitoring data from temperature data captured over a period of time, wherein the monitoring data includes a number of temperature measurements associated with the at least two sensors.

10. The method of claim 9 further comprising:
analyzing the monitoring data using a gradient detector.

11. The method of claim 9 further comprising:
outputting a result using the analysis of the monitoring data.

12. The method of claim 9 further comprising:
storing the monitoring data in a number of storage devices.

13. A monitoring system comprising:
one or more sensor systems configured to monitor a subject for change in temperature and generate temperature data; and
a processing unit configured to process the temperature data to generate a result.

14. The monitoring system of claim 13, wherein the result is at least one of a report, an output, or a diagnosis.

15. The monitoring system of claim 13, wherein each of the one or more sensor systems comprises:
a plurality of thermal sensors in isolation; and
one or more thermal isolating layers.

16. The monitoring system of claim 15, wherein each of the one or more sensor systems comprises:
a data collector configured to capture temperature data from the plurality of thermal sensors.

17. The monitoring system of claim 16, wherein the temperature data includes a number of temperature measurements, and wherein each of the number of temperature measurement is associated with a point in time.

18. The monitoring system of claim 13, wherein the processing unit processes the temperature data to generate monitoring data.

19. The monitoring system of claim 13, wherein the processing unit analyzes the monitoring data using one or more algorithms.

20. The monitoring system of claim 13, wherein the subject is a human.
